(19) United States
(12) Patent Application Publication
(10) Pub. No.: US 2007/0156259 A1
(43) Pub. Date: Jul. 5, 2007

(54) System generating output ranges for model predictive control having input-driven switched dynamics

(76) Inventors: Lubomir Baramov, Prague (CZ); Vladimir Havlena, Ptrague (CZ)

Correspondence Address: HONEYWELL INTERNATIONAL INC., 101 COLUMBIA ROAD, P O BOX 2245, MORRISTOWN, NJ, 07962-2245, US

(21) Appl. No.: 11/323,280

(22) Filed: Dec. 30, 2005

(51) Int. Cl. G05B 13/02

(52) U.S. Cl. 700/44

(57) ABSTRACT

A system for having input-driven output ranges for model predictive control. The system may involve range control and may use a particular formulation of a model predictive control (MPC) for determining the predicted future output trajectory from a set called range. The range may be defined for each output (i.e., controlled variable) on a prediction horizon by the range upper and lower bounds.

### BACKGROUND

The invention may pertain to predictive controllers, and particularly to advanced process control, model predictive control, range control, and switched dynamical systems.

The invention may be related to U.S. Pat. No. 5,351,184, issued Sep. 27, 1994, and entitled “Method of Multivariable Predictive Control Utilizing Range Control”, which is hereby incorporated by reference. The invention may also be related to U.S. Pat. No. 5,561,599, issued Oct. 1, 1996, and entitled “Method of Incorporating Independent Feedforward Control in a Multivariable Predictive Controller”, which is incorporated herein by reference.

### SUMMARY

The invention involves range control and may use a particular formulation of a model predictive control (MPC) for determining the predicted future output trajectory from a set called range. The range may be defined for each output (i.e., controlled variable) on the prediction horizon by the range upper and lower bounds.

### BRIEF DESCRIPTION OF THE DRAWING

FIG. 1a shows a relationship between an auxiliary variable and predicted plant output;

FIG. 1b shows a penalty on the predicted plant output;

FIG. 2 shows a classical funnel shape of the CV range;

FIG. 3 is a diagram of a range response generator;

FIGS. 4a and 4b show examples of linear system responses for piecewise constant inputs;

FIGS. 5a and 5b show examples of linear system responses for piecewise linear inputs;

FIG. 6 is a block diagram of a system having input-driven output ranges for model predictive control;

FIG. 7 is a flow diagram for one time step in sync with model predictive control;

FIG. 8 is a flow diagram showing a possible implementation of the state-update function;

FIGS. 9a, 9b and 9c are plots of closed-loop responses to a set-range step for the classical funnel;

FIGS. 10a, 10b and 10c are plots of closed-loop responses to a set-range step for an input-driven range;

FIGS. 11a, 11b and 11c are plots of closed-loop responses to a set-range pulse for the classical funnel; and

FIGS. 12a, 12b and 12c show closed-loop responses to a set-range pulse for an input-driven range.

### DESCRIPTION

Earlier art either does not necessarily specify an algorithm for generating the ranges or use the so-called funnels which are based on the current measured or estimated value of controlled variables (CV's) and the operator set-range. Such art may use a simple static mapping of the variables on range bounds. Some background information may be disclosed in U.S. Pat. Nos. 5,351,184 and 5,561,599.

This invention concerns generating range bounds for an MPC with a range control algorithm as output predictions of a switched dynamical system driven by external inputs. These inputs may include operator-set ranges and measured disturbances.

The internal dynamics of a switched system may be configured to be an approximation of expected closed loop dynamics; thus, the ranges obtained can be realistic target sets for future CV trajectories avoiding abrupt changes thus resulting in calm control avoiding excessive peaks in manipulated variables.

The ranges thus generated may be time invariant in the sense that they follow their predictions computed in the past, unless external conditions change (in particular, anticipated values of future inputs). Therefore, as the target sets for CV's are time-invariant (and hence predictable), one may expect that also the realized CV's and manipulated variables (MV's) will approximately follow their predictions.

The internal dynamics of the switched system may be designed in a way that the range upper/lower bounds follow, during transitions, trajectories of linear systems. Thus, the ranges make natural target sets for trajectories of physical systems, without corners and bottlenecks, further improving calmness and robustness of MPC control.

As the algorithm for generating ranges is based on predicting output trajectories of a switched dynamical system, it may allow considering changes of inputs in the future.

This invention may generate the range as future output predictions for a switched dynamical system, driven not only by the CV set-range but also by other process inputs, e.g., disturbances. Here, expected future input changes may be taken into account.

The range control may use a particular formulation of MPC, penalizing the distance of the predicted future output trajectory from a set called range. The range may be defined for each output (controlled variable) on the prediction horizon by the range upper and lower bounds; these bounds generated at time k may be represented by the vector [Y_{L}(k|k), Y_{L}(k+1|k), . . . , Y_{L}(k+N|k), Y_{H}(k|k), Y_{H}(k+1|k), . . . , Y_{H}(k+N|k)]. If the range lower and upper bounds are identical, the range may degenerate into a so-called reference signal which appears in common MPC formulations. If the underlying optimization problem of MPC penalizes both distances of the predicted CV trajectories from the ranges and the magnitudes of the current and future changes of manipulated variables (MV's), the resulting control may be particularly calm and robust, i.e., insensitive to noises and model uncertainties. A specific formulation of this optimization problem may be noted here.

A formulation of range control algorithm may be presented. One may consider the following optimization problem:

$${min}_{{{u}_{s} ( k + i \vert k ) , i ∈ {𝒥}_{Us}}_{{z}_{p} ( k + j \vert k ) , j ∈ {𝒥}_{yp}}} {\sum }_{p = 1}^{{n}_{y}} ( {\sum }_{j ∈ {𝒥}_{yp}} {( {\hat{y}}_{p} ( k + j \vert k ) - {z}_{p} ( k + j \vert k ) )}^{2} {Q}_{yp} ) + {\sum }_{s = 1}^{{n}_{u}} ( {\sum }_{i ∈ {𝒥}_{Us}} Δ {{u}_{s} ( k + i \vert k )}^{2} {Q}_{us} + {( {u}_{s} ( k + N \vert k ) - {u}_{sT} ( k ) )}^{2} {Q}_{Ts} ) \qquad ( 1 )$$

In this equation, ŷp(k+j|k), p=1, . . . , n_{y} is the optimal CV value at t=k+j predicted at t=k. Next, uₛ(k+i|k), s=n, . . . , nᵤ is the control input (manipulated variable) trajectory, which is subject to optimization at time k. Its increments are
Δuₛ(k+i|k)=uₛ(k+i|k)−uₛ(k+i−1|k)
for i=, . . . , N and
Δuₛ(k|k)=uₛ(k|k)−uₛ(k−1|k−1)
Future CV values may be expressed as linear functions of future MV values by means of a suitable prediction model. Other optimization variables may be auxiliary variables z,(k+j|k). Variable u_{sT} is a target for manipulated variable, which is supplied by an external steady-state optimizer.

Further, ℑ_{Yp} and ℑ_{Us} are blocking sets for CV's and MV's, respectively. Manipulated variables are fixed so that uₛ(k+i|k)=uₛ(k+i−1|k) for i∉ℑ_{Us}. Moreover, 0εℑ_{Us}. Constants Q_{yp}, Qᵤₛ and Q_{Ts} are non-negative numbers, weighting parameters chosen to emphasize/de-emphasize a particular penalty term.

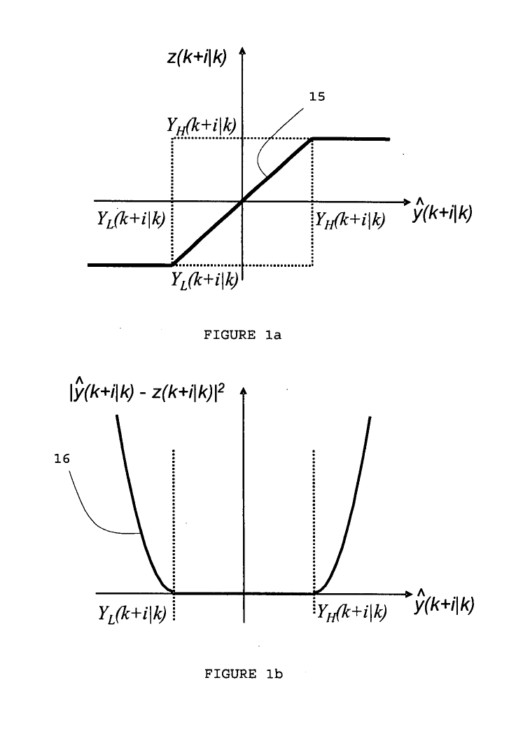

The above cost function may be minimized with respect to the following constraints:
Uₛₘᵢₙ≦uₚ(k+i|k)≦U _{s max} s=1, . . , nᵤ, iεℑ_{Us} (2)
dU_{s min}≦Δuₛ(k+i|k)≦dU_{s max} s=1, . . . ,nᵤ, iεℑ_{Us}
Y_{pL}(k+j|k)≦zₚ(k+j|k)≦Y_{pHj}(k+j|k) p=1, . . . , n_{y}, jεℑ_{Yp}
The CV range may be defined by the third set of constraints in equation (2). The first penalty term in equation (1) penalizes the squared distance of ŷp(k+j|k) from the interval
[Y_{pL}(k+j|k),Y_{pH}(k+j|k)],
as shown in FIGS. 1a and 1b. FIG. 1a shows a relationship between the auxiliary variable z and predicted plant output, which is shown as a plot 15 of z(k+i|k) versus ŷ(k+i|k). FIG. 1b shows the penalty on predicted plant output, which is shown as a plot 16 of |ŷ(k+i|k)−z(k+i|k)|² versus ŷ(k+i|k).

The problem formulation equations (1) and (2) may be modified in various ways; the key attribute of the range-control algorithm appears to be the existence of a range for the future CV trajectory such that if the predicted CV trajectory is within the range, it does not contribute to the cost function, and the optimizer can concentrate on other penalty terms such as MV increments and steady-state targets. Hence, a non-degenerate range (where the upper bound is strictly larger than the lower one) has an important calming and robustifying effect on the optimal Mv.

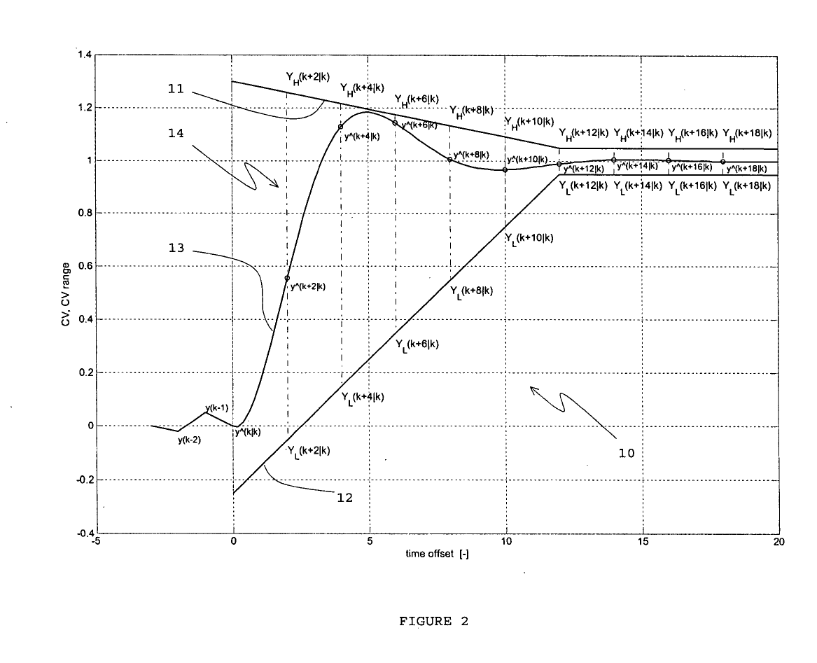

As is usual in model predictive control, only the first computed MV step uₛ(k|k), s=1, . . . , nᵤ is applied; after that, the time instant k is incremented by one and the whole process is repeated. This invention deals with generating the range {[Y_{pL}(k+j|k),Y_{pH}(k+j|k)]}ⱼ₌₀^{N} for all time instants k. These ranges are generated for each output independently, and therefore one may omit the index p. There may be a specific formula for the range; it is a common practice that the range bounds are piecewise linear, for their typical shape the ranges are referred to as ‘funnels’. An example of a funnel is in FIG. 2. This Figure shows a classical funnel 10 shape of the CV range versus time offset.

A current CV estimate 13 and its future predictions made at time k are denoted as ŷ(k|k), . . . , ŷ(k+N|k). The funnels have typically the following properties: first, the funnel upper bound 11 and lower bound 12 are, at a time segment at the end of the horizon, equal to the operator-set bounds yₗ(k) and yₕ(k), which define the set range for the CV. Second, the current CV estimate 13 ŷ(k|k) is within the funnel opening 14, i.e., the interval [Y_{L}(k|k), Y_{H}(k|k)]. Finally, the gap of the funnel opening 14 narrows as ŷ(k|k) gets closer to the set range [yₗ(k), yₕ(k)], until it reaches a minimum width. Hence, the funnel bounds 11 and 12 are computed at each step as a piecewise linear function from variables yᵢ(k), yₕ(k), ŷ(k|k) and a few other parameters defined off-line. The funnel shape is the main tuning parameter for controller performance. A modification may be that the funnel 10 shape can be tuned for disturbance rejection without regard for the set-range performance tracking; the set-range inputs yᵢ(k), yₕ(k) may then be pre-filtered to avoid an overly aggressive response to step changes in these variables.

This invention presents a new way of generating the ranges for MPC, which may result in further improvement of performance while preserving calm and robust control. New features of the presented solution which have not been addressed and which solve practically relevant problems may be as follows. First, the range-generation may have its own dynamics driven by relevant known inputs to the controlled process. The internal dynamics of the range generator may model approximately the inertias of the closed loop and by taking into account-the past inputs; it may produce ranges which do not necessarily cause excessive moves of manipulated variables computed by MPC. Second, the computed ranges may be time-invariant, i.e., Y_{L}(k+j|k)=Y_{L}(k+j|k−s), Y_{H}(k+j|k)=Y_{H}(k+j|k−s) for all k and the sum j+s not exceeding the horizon N (on condition that the external inputs evolve as predicted in the past). The range thus may be understood as a response target set and the optimal MV and CV trajectories are thus more consistent with their predictions in the past than when using previous algorithms.

Third the ranges may take into account anticipated future inputs. Fourth, the ranges may be tailored to particular classes of inputs (e.g., steps, ramps, periodic signals). Fifth, the ranges may take the shape of linear systems responses rather than piecewise-linear funnels. Thus, the controller does not have to make an effort to bend the trajectories around corners, resulting in calmer control. Moreover, the ranges do not necessarily have bottlenecks in places where the predicted transitional responses are sensitive to uncertainties, thus further improving robustness.

The present invention may meet a need. The range for a particular CV may be driven by external inputs including set-range bounds and disturbances. For each of these inputs, a partial range may be computed and the resulting CV range may be a composition of the partial ranges. The partial upper and lower range bounds may be obtained from responses of switched dynamical systems to the particular input. The internal switches may change their states according to the (suitably defined) size and direction of the driving inputs. Specifically, during a transient, the range lower bound may follow the response of a dynamical subsystem, while the upper bound may be a response of another subsystem, so that there is a sufficient gap between these responses. For transients in the opposite direction, the subsystems may be interchanged. The partial range bounds may be obtained as output predictions of these switched systems on the receding horizon. Anticipated future inputs may be included in the prediction formulas. Asymptotic tracking of the set-range or rejection of a disturbance of particular class may be achieved by a proper design of the switched system. If the sub-systems are linear, the range bounds may have the shape of linear system responses during the transients.

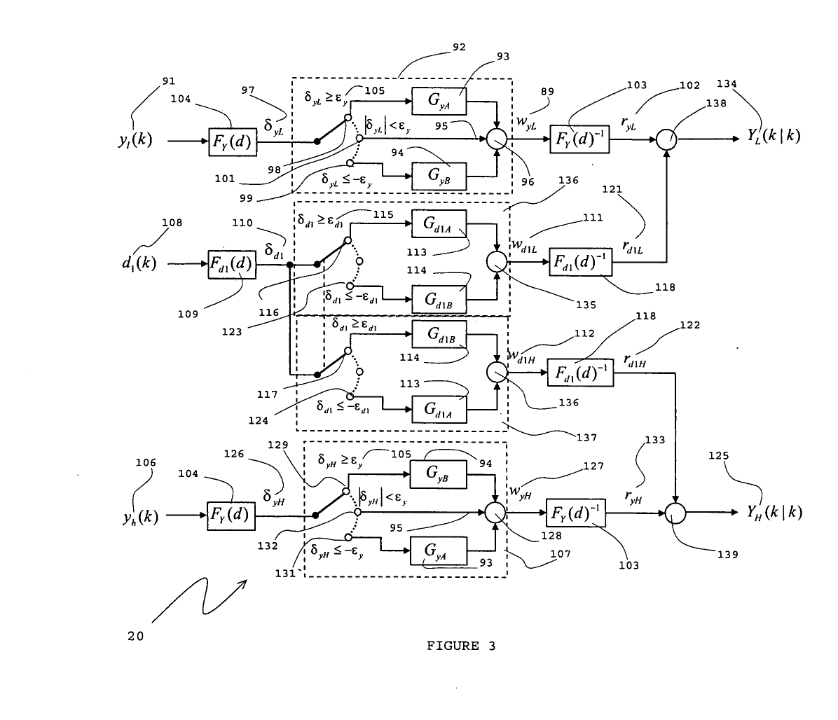

One way to make this invention may follow from the block diagram for a range response generator 20 in FIG. 3 for one CV and one disturbance variable (DV). This generator 20 may be one implementation of several of this range generator as a switched system. If there are multiple outputs, the ranges may be generated independently; to reflect the multi-output nature of the process with cross-channel coupling, the set-range bounds of one CV may be considered disturbance inputs to range generators for other CV's and vice versa. The structure 20 of FIG. 3 may be extended to more than one DV.

In this configuration, the set-range lower bound yₗ affects only the range lower bound Y_{L} and similarly, yₕ affects only Y_{H}. This structure 20 may include also the cases when cross-couplings from yᵢ to Y_{H} and yₕ to Y_{L} are at place. Disturbances may affect both the lower and the upper bounds in a symmetric manner. A modification may include cases where the disturbance value is replaced by its upper and lower estimates (denoted as d₁ₗ and d₁ₕ, respectively); as with the set-range, d₁ₗ and d₁ₕ may affect the CV range lower and upper bounds respectively, or each of the DV bounds may contribute to both the CV range bounds.

Transformation of an input into a partial range bound may depend on the model selected for the particular input. Input signals may be represented by auto-regressive models; for an input u, this model is given by equation (3).
u(k)=a₁u(k−1)+a₂u(k−2)+ . . . +aₙu(k−n)+δₙ(k) (3)
The variable denoted as δᵤ is the error; variables α₁, . . . , αₙ are parameters of the model. An equivalent way of representing this model may be using the operator form. Let d be one-step delay operator; then the model given by equation (3) may be represented as in equation (4).
Fᵤ(d)u=δᵤ, Fᵤ(d)=1−aₗd−a₂d₂− . . . −aₙdⁿ (4)
An ideal class of inputs given by an autoregressive model may be that whose error signal is zero almost everywhere except of a set of isolated time samples. Examples of common input classes may be piecewise constant signals (sequence of steps) given by the operator Fᵤ(d) in equation (5);
Fᵤ(d)=1−d. (5)
In that case, the error function δᵤ may be zero everywhere, except of those sampling intervals where the step occurs. Similarly, the operator for piecewise linear inputs (sequence of ramps) may be given in equation (6).
Fᵤ(d)=1−2d+d² (6)
Finally, piecewise harmonic signals of angular frequency ω may be represented by the operator model in equation (7),
Fᵤ(d)=1−2cos(ωT)d+d², (7)
where T denotes the sampling period. Input signals considered for the practical use of the invention need not strictly belong to an ideal class, but only to some degree of approximation; for instance, δ may be a mixture of a zero-mean, low variation noise and a distribution of random pulses.

Referring to FIG. 3, error signal δ may be obtained from every input entering the range generator 20. This may be done by applying the particular operator Fᵤ(d) on the system input; in other words, this operator may compute a from equation (3) using recorded past input values. There might be issues for input models of order two and higher, as those in equations (6) and (7), if the input signals are corrupted by measurement noise. Operators Fᵤ(d) may amplify noise components significantly, making the extraction of any useful information about the input trends from the error signal δ difficult. However, this issue may be avoided by preprocessing the input by a non-causal smoothing filter, which is run at each step k on the time window k−M, k−M+1, . . . , k, k+1, . . . k+N. This filter may need future input values which may also be needed by MPC.

It may be a practice in MPC that the input is assumed constant in the future, taking the last known value, if there is no further information available. Alternatively, it may be extrapolated using the model of equation (3) where future error signal δᵤ is assumed zero. Moreover, there may be cases when relevant information about future input development can be obtained from, e.g., other MPC's controlling related processes in the plant, or optimizers coordinating several process controllers.

Data smoothing is not necessarily a subject of this invention. A suitable algorithm may be found in Gustafsson, F., “Determining the Initial States in Forward-Backward Filtering” in IEEE Transactions on Signal Processing, Vol. 44, No 4, April 1996, or in “Signal Processing Toolbox for use with Matlab, User's Guide, Version 5”, The Mathworks, Inc, Natick, Mass.

The error signal extracted from each output may be fed to a switched dynamical system. In FIG. 3, one may follow the path of signal 97, δ_{yL}, obtained from the lower set-range bound 91, δ_{yl}. It may be fed to a switched linear system 92 whose output 89, denoted as w_{yL} is a sum 96 of outputs of two dynamical systems 93, G_{yA}, and 94, G_{yB}, and a unit-gain (direct feed through) 95. If, at a particular time-step k, the signal 97, δ_{yL}, is positive and greater than or equal to a certain threshold 105, ε_{y}, at switch position 98, then signal 97, δ_{yL}, may drive the system 93, G_{yA}, while system 94, G_{yB}, evolves freely. If signal 97, δ_{yL}, is negative and less than or equal to the opposite value of the threshold 105, ε_{y}, at switch position 99, then system 94, G_{yB}, may be driven and system 93, G_{yA}, may be free. In both these cases, the input 101 of the unit gain 95 may be zero. Finally, if the absolute value of signal 97, δ_{yL}, is less than the threshold 105, ε_{y}, then both the dynamical systems 93, G_{yA}, and 94, G_{yB}, may be undriven and signal 97, δ_{yL}, be connected directly to the switch position or input 101 of the unit gain 95. The contribution of the lower set-range bound 91, yₗ, to the range lower bound 102, denoted as r_{yL}, may be obtained by applying the inverse operator 103 of F_{y}(d) 104 to signal 89, ω_{yL}. That contribution may be computed using equation (3), where one substitutes the switched linear system 92 output 89, ω_{yL}, for δᵤ and the range lower bound 102, r_{yL}, for an input u. Note that for the current function of the system 92 it may be necessary to initialize consistently the input operator 104, F_{y}(d), and its inverse 103 at the output. Assuming that the system initialization occurs at time k=0, one may set the internal variables of the operators (which are normally the past data) as in equation (8).
yₗ(−i|0)=r_{yL}(−i|k), i=1, 2, . . . , n (8)
Specific values for these initial conditions may be chosen according to the initial value of the controlled variable. The role of the threshold 105, ε_{y}, may be regarded to prevent excitation of the range dynamics by small amplitude components of δ_{y}, which may arise from noise, or small operator interventions.

The mapping of the set-range bound 106, yₕ, to the CV range upper bound 125, Y_{H}, may be entirely symmetric to the previous case, where the mapping of the set-range bound 91, yₗ, is to the CV range lower bound 134, Y_{L}. The input model represented by operator 104, F_{y}(d), may be the same for the upper set-range bound 106, yₕ, and the lower set-range bound 91, yₗ, and so may be the threshold 105, ε_{y}; the switched systems 107 and 92 may the same but the roles of dynamical systems 93, G_{yA}, and 94, G_{yB}, are interchanged.

As another instance where the error signal extracted from each output may be fed to a switched dynamical system, one may follow the path of signal 126, δ_{yH}, obtained from the upper set-range bound 106, Yₕ. It may be fed to a switched linear system 107 whose output 127, denoted as ω_{yH}, is a sum 128 of outputs of two dynamical systems 93, G_{yA}, and 94, G_{yB}, and a unit-gain (direct feed through) 95. If, at a particular time-step k, the signal 126, δ_{yH}, is positive and greater than or equal to a certain threshold 105, ε_{y}, at switch position or input 129, then signal 126, δ_{yH}, may drive the system 94, G_{yB}, while system 93, G_{yA}, evolves freely. If signal 126, δ_{yH}, is negative and less than or equal to the opposite value of the threshold 105, ε_{y}, at switch position or input 131, then system 93, G_{yA}, may be driven and system 94, G_{yB}, may be free. In both these cases, the switch position or input 132 of the unit gain 95 may be zero. Finally, if the absolute value of signal 126, δ_{yH}, is less than the threshold 105, ε_{y}, both the dynamical systems 93, G_{yA}, and 94, G_{yB}, may be undriven and signal 126, yH, be connected directly to the switch position or input 132 of the unit gain 95. The contribution of the lower set-range bound 106, yₕ, to the range upper bound 133, denoted as r_{yH}, may be obtained by applying the inverse operator 103 of F_{y}(d) 104 to signal 127, w_{yH}. That contribution may be computed using equation (3), where one substitutes the switched linear system 107 output 127, w_{yH}, for δᵤ and the range lower bound 133, r_{yH}, for an input u. Note that for the current function of the system 107, it may be necessary to initialize consistently the input operator 104, F_{y}(d), and its inverse 103 at the output. Assuming that the system initialization occurs at time k=0, one may set the internal variables of the operators (which are normally the past data) as in equation (8), replacing yₗ by yₕ and r_{yL} by r_{yH}. Specific values for these initial conditions may be chosen according to the initial value of the controlled variable.

The dynamic systems 93, G_{yA}, and 94, G_{yB}, should satisfy certain assumptions to guarantee that the bounds do not cross and that the CV range tracks the target set-range; let δ₀(k) be the unit pulse signal; define the signals h_{yA}, h_{yB} and h_{y0}, as in equation (9),
h_{yA}(k)=F_{y}(d)⁻¹G_{yA}δ₀(k); h_{yB}(k)=F_{Y}(d)⁻¹G_{yB}δ₀(k); h_{y0}(k)=F_{y}(d)⁻¹δ₀(k); (9)
as impulse responses from the respective poles of the switch to the output range bound. The following assumptions may be made
i. Inequality of the bounds: h_{yA}(k)<=h_{yB}(k) for k=0, 1, . . .
ii. Convergence: h_{yA}(k) and h_{yB}(k) asymptotically converge to h_{y0}(k).
iii. Initial values: h_{yA}(O)<=0 and h_{yB}(0)>=0.
iv. Prohibiting over- and under-shooting the reference h_{y0}:
∘ h_{yA}(k)<=h_{y0}(k) for k=0, 1, . . .
∘ if h_{yB}(0)>=h_{y0}(0), then h_{yB}(k)>=h_{y0}(k) for all k=0, 1, . . . ; otherwise, there exists a k₀ so that h_{yB}(k)<=h_{y0}(k) for k <=k₀ and h_{yB}(k)>=h_{y0}(k) for k>k₀.

These assumptions may be sufficient for producing a feasible CV range, if the set-range bounds are feasible. If the set-range bounds are equal or separated by a constant offset, these assumptions may be reduced to i-ii.

As can be seen from FIG. 3, disturbance 108, dₗ, may be processed in a similar way: first, an input model represented by operator 109, F_{dl}(d), is chosen; applying this operator may yield the error 110, δ_{dl}. For the range bounds, variables 111, W_{dlL}, and 112, W_{dlH}, respectively, may be obtained as sums 135 and 136, respectively, of responses of pairs of dynamic systems 113, G_{dlA}, and 114, G_{dlB}, of systems 136 and 137 If the error 110, δ_{dl}, is greater than or equal to threshold 115, ε_{dl}, it may be switched to the position or input 116 of dynamic system 113, G_{dlA}, to update the lower range bound, and to the switch position or input 117 of dynamic system 114, G_{dlB}, to update the upper range bound. If the error 110, δ_{dl}, is smaller than or equal to the opposite value of the threshold 115, ε_{dl}, it may be switched to the position or input 123 of dynamic system 114, G_{dlB}, to update the lower range bound, and to the switch position or input 124 of dynamic system 113, G_{dlA}, to update the upper range bound. If the absolute value of error 110, δ_{dl}, is smaller than the threshold 115, ε_{dl}, it may be switched to neither of the systems 113 and 114. Then, variable 111, w_{dlL}, and variable 112, w_{dlH}, thus obtained, may be processed by the inverse operators 118 of input operator 109, F_{dl}(d), to get the respective partial lower range bound 121, r_{dlL}, and partial upper range bound 122, r_{dlH}. As for the initialization, the input operator 109, F_{dl}(d), may have its initial conditions set to zero and so the inverse operators 118 generate the partial range bounds 121 and 122. The partial range lower bounds 102 and 121 may be brought together at a summer 138 to provide the CV range lower bound 134. The partial range upper bounds 133 and 122 may be brought together at a summer 139 to provide the CV range upper bound 125.

One may introduce two impulse responses: h_{dlA} and h_{dlB} as in equation (10).
h_{dlA}=F_{dl}(d)⁻¹G_{dlA}δ₀, h_{dlB}=F_{dl}(d)⁻¹G_{dlB}δ₀ (10)
To achieve feasibility of the bounds, the following additional assumptions may be made.
v. Inequality of the bounds: h_{dlA}(k)<=h_{yB}(k) for k=0, 1, . . .
vi. Convergence: h_{dlA}(k) and h_{dlB}(k) converge to zero.

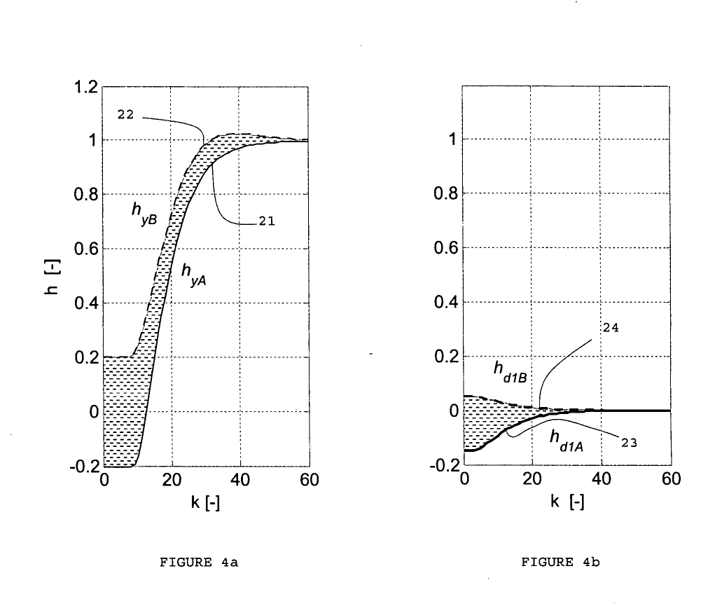

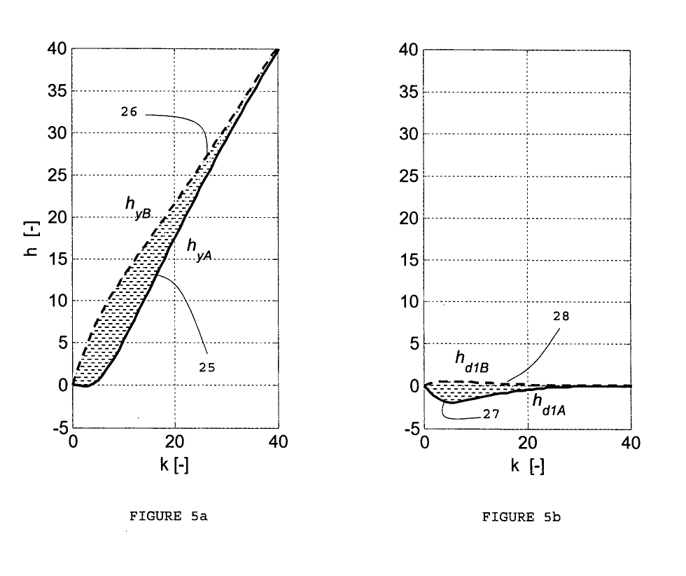

Defining the systems G_{yA}, G_{yB}; G_{dlA}, and G_{dlB}, which satisfy conditions i-vi above and such that their responses (to the respective input classes) make suitable target responses for the closed loop may be a problem of dynamical system synthesis. Examples of linear system responses h_{yA}, h_{yB}, h_{dlA} and h_{dlB}, are shown in FIGS. 4a and 4b for piecewise constant inputs, as shown by plots 21, 22, 23 and 24, respectively, for h versus k. Also, examples of linear system responses h_{yA}, h_{yB}, h_{dlA} and h_{dlB}, are shown in FIGS. 5a and 5b for piecewise linear inputs, as shown by plots 25, 26, 27 and 28, respectively, for h versus k. FIGS. 4a and 4b show normalized range responses to steps in the set-range and disturbance, respectively. FIGS. 5a and 5b show the range responses to ramps in the set-range and the disturbance, respectively. These responses may define the range for the normalized unit-change transitions in the given class of input signals (i.e., nonzero width at the end of the horizon may be achieved by non-zero width of the steady-state set-range).

The switched system thus defined may produce, at time k, the range opening intervals Y_{L}(k|k) and Y_{H}(k|k). The whole range [Y_{L}(k|k), Y_{L}(k+l|k), . . . , Y_{L}(k+N|k), Y_{H}(k|k), Y_{H}(k+1|k), . . . , Y_{H}(k+N|k)] may be computed by a prediction algorithm, which depends on the internal representation of the above mentioned dynamical systems (e.g., state-space equations, a polynomial-operator model). A particularly simple form of implementing this range generator may be the prediction formula based on finite responses (used, for instance, in DMC, dynamic matrix control for predicting process outputs). In that case, the range dynamics may be represented by responses h_{yA}(k), h_{yB}(k), h_{dlA}(k) and h_{dlB}(k) on the interval 0, . . . , N. These responses may be pre-computed off-line. For a simple user interface, they may be parameterized by a few parameters, which define some geometrical properties of the responses (such as tangents, inflection points). An attention should be paid, however, to attaining the limits of convergence assumptions ii and vi within the prediction horizon to a high degree of accuracy. These responses may be typically generated by linear systems, as those in FIGS. 4a and 4b and FIGS. 5a and 5b.

However, the linearity is not necessarily required. A possible way of implementing this invention may be also to define responses h_{yA}(k), h_{yB}(k), . . . as piecewise linear functions. Whatever method is used for the prediction, anticipated future inputs may be taken into account by the range generating algorithm. Future trajectories may be pre-processed in any way, e.g., smoothened, or ramped (applying a rate-of-change limiter).

The concept of input-driven ranges outlined above may have no feedback from process CV. This may be consistent with the idea of ranges as targets for process responses to be met by the controller. However, if the process is subject to an unknown disturbance, or the internal MPC model is not sufficiently precise, the process CV may be driven away from the range, causing an overly aggressive MV response with possible loss of robustness. For that reason, a feedback from the process CV to the range generator may be desirable. A straightforward way may be to detect the situation when the CV is carried far from the range and then to reset the internal dynamics of the switched system to obtain a range which contains the current CV value in its opening interval and coincides with the set-range at its end. Upon a reset, the range may be computed in a similar way as the funnels in the standard algorithm. However, once the CV is, after the reset, within the range opening, the system may resume its input driven operation. An alternative (or complementary) way of introducing feedback may be estimating unknown disturbances (for instance, using Kalman filter) and then feeding the estimates to the range generator as known disturbances.

A specific algorithm, for input-driven ranges, as a possible implementation of this invention having piecewise constant inputs may be provided here. The model for the inputs may be assumed to be given by equation (5), i.e., piecewise constant. The inputs of this algorithm are shown in the following table.

TABLE 1

| | |
|---|---|
| ŷ(k\|k) | Current CV estimate |
| yₗ(k),ŷₗ(k + 1\|k),...,ŷₗ(k + N\|k) | Current set-range lower bound |
| | and its currently anticipated |
| | future values |
| yₕ(k),ŷₕ(k + 1\|k),...,ŷₕ(k + N\|k) | Current set-range upper bound |
| | and its currently anticipated |
| | future values |
| d₁(k),\hat{d}₁(k + 1\|k),...,\hat{d}₁(k + N\|k) | Current DV #1 and its future |
| | predictions |
| . | |
| . | |
| . | |
| dₘ(k),\hat{d}ₘ(k + 1\|k),...,\hat{d}ₘ(k + N\|k) | Current DV #m and its future |
| | predictions |

It may be noted that current CV estimate ŷ(k|k) should be used only for performing a test if the funnel is to be initialized, and for the initialization. Values of future inputs, if not available, may be set to the current value.

The states of this algorithm listed in the following table 2.

TABLE 2

| | |
|---|---|
| x(1),···,x(N + 1) | last lower bound generated by |
| | ‘realized’ input increments |
| x(N + 2),···,x(2N + 2) | last upper bound generated by |
| | ‘realized’ input increments |
| x(2N + 3) = yₗ(k − 1) | Past value of set-range lower |
| | bound |
| x(2N + 4) = yₕ(k − 1) | Past value of set-range upper |
| | bound |
| x(2N + 5) = d₁(k − 1) | Past value of disturbance #1 |
| . | |
| . | |
| . | |
| x(2N + 4 + m) = dₘ(k − 1) | Past value of disturbance #m |

The outputs of the algorithm may be the range bounds [Y_{L}(k|k) . . . Y_{L}(k+N|k)|Y_{H}(k|k) . . . Y_{H}(k+N|k)]^{T}.
The algorithm parameters may be the impulse responses h_{yA}(j), h_{yB}(j), h_{dlA}(j), h_{dlB}(j), . . . h_{dmA}(j), h_{dmB}(j) defined in equations (9) and (10) and satisfy assumptions i-vi above, for j=1, . . . , N and the switching thresholds ε_{y}, ε_{dl}, . . . ε_{dm}.
The state update may be performed by invoking the function
function x_{new}=F_{update}(x,Y_{newL},Y_{newH}, D_{new}, N)
The call for the real state update uses the ‘current’ values of CV set-range and disturbances. The body of the function may then be as follows. First, do the following substitutions and initializations:
Y_{lastL}=x(2N+3), Y_{lastH}=x(2N+4);
dr_{L}=Y_{newL}−Y_{lastL}, dr_{H} Y_{newH}−Y_{lastH;}
Then, shift the bounds due to moving the time window:
x(1:N+1)=[x(2:N+1) Y_{lastL}]; x(N+2:2N+2)=[x(N+3:2N+3) Y_{lastH}] (11)
Now, add the contribution of the set-range change, which is either the particular step response multiplied by the input change size or a plain increment by the input change; the lower bound becomes:

$$x ( 1 + j ) = x ( 1 + j ) + \{ \begin{matrix}{h}_{yA} ( j ) \cdot {dr}_{L} & if {dr}_{L} \geq {ɛ}_{y} \\ {h}_{yB} ( j ) \cdot {dr}_{L} & if {dr}_{L} \leq - {ɛ}_{y} \\ {dr}_{L} & otherwise\end{matrix} \\ for j = 0 , … , N \qquad ( 12 )$$

and the higher bound is updated analogously as

$$x ( N + 2 + j ) = x ( N + 2 + j ) + \{ \begin{matrix}{h}_{yB} ( j ) \cdot {dr}_{H} & if {dr}_{H} \geq {ɛ}_{y} \\ {h}_{yA} ( j ) \cdot {dr}_{H} & if {dr}_{H} \leq - {ɛ}_{y} \\ {dr}_{H} & otherwise\end{matrix} \\ for j = 0 , … , N \qquad ( 13 )$$

Then, the recorded past inputs are updated as
x(2N+3)=Y_{newL}, x(2N+4)=Y_{newH}

Here, one may make a note on the connection of this algorithm to FIG. 3. Error variables δ_{yL} and δ_{yH} are denoted here as dr_{L} and dr_{H}, respectively. Switch poles 98, 99 and 101 of FIG. 3 correspond to the cases in equation (12); similarly, switch poles 129, 131 and 132 correspond to the cases in equation (13). Transfer functions G_{yA} and G_{yB} have corresponding impulse responses g_{yA} and g_{yB}, respectively. The inverse input operator F_{y}(d)⁻¹ is, in the case under consideration, an integrator. Integrated impulse responses g_{yA} and g_{yB} are step responses h_{yA} and h_{yB}. respectively, used in equations (12) and (13).

The contributions from other inputs may be done similarly; the only difference is that there is only one disturbance value, instead of ‘low’ and ‘high’ values for the set-ranges (although, ranges for noisy and uncertain disturbances may be considered in the future). For i-th disturbance i=1, . . . , m, one may have

$$\begin{matrix}{D}_{last} = x ( 2 N + 4 + i ) ; \\ dD = {D}_{new} ( i ) - {D}_{lastL} ; & \\ x ( 1 + j ) = x ( 1 + j ) + \{ \begin{matrix}{h}_{diA} ( j ) \cdot dD & if dD \geq {ɛ}_{di} \\ {h}_{diB} ( j ) \cdot dD & if dD \leq - {ɛ}_{di}\end{matrix} \\ for j = 0 , … , N & ( 14 ) \\ x ( N + 2 + j ) = x ( N + 2 + j ) + \{ \begin{matrix}{h}_{diB} ( j ) \cdot dD & if dD \geq {ɛ}_{di} \\ {h}_{diA} ( j ) \cdot dD & if dD \leq - {ɛ}_{di}\end{matrix} \\ for j = 0 , … , N & ( 15 )\end{matrix}$$

and the past-value update
x(2N+4+i)=D_{new} (i)
Setting the output parameter x_{new}=x may conclude the state update function.

For computing output bounds, one may start by checking if it is not necessary to initialize the state. This should be done either at startup, or if the output trajectory drifts too far from the range due to unexpected disturbances. The range bounds may be set to be a constant, the lower one being less than the current value.

if ‘startup’ or max(x(2) − ŷ(k | k),ŷ(k | k) − x(N + 3)) >
init_threshold

$x ( i ) = \{ \begin{matrix}\hat{y} ( k \vert k ) - {D}_{0} & for i = i , … , N + 1 ; 2 N + 3 \\ \hat{y} ( k \vert k ) + {D}_{0} & for i = N + 1 , … , 2 N + 2 ; 2 N + 4 \\ 0 & otherwise\end{matrix}$

end

Now, one may perform the state-update and copy the updated states in the temporary state variable y,
x=F_{update}(x, y₁(k), yₕ(k), [d₁(k), . . . dₘ(k)], N);
y=x;

next, one may take into account expected future input changes,

for i = 1:N

y([1 + i:N + 1,N + 2 + i:end]) =

F_{update} (y([i:N,N + 1 + i:2N + 1,2N + 3:end]),ŷₗ(k + i|k),ŷₕ(k +
i|k),... (16)

[\hat{d}₁(k + i|k),...,\hat{d}ₘ(k + i|k)],N − i);

end

then, one may extract the lower and the upper bounds,
y_{L}=y(1:N+); y_{H}=y(N+2:2N+1); (17)
one should prevent bounds crossing, or do not allow bounds coming closer than pre-defined gap Δ_{B}>0 for:

$$I = \{ i , ( {y}_{H} ( i ) - {y}_{L} ( i ) ) < {Δ}_{B} \} ;$$

$${y}_{H} ( i ) = \frac{1}{2} ( {y}_{H} ( i ) + {y}_{L} ( i ) + {Δ}_{B} ) , ∀ i ∈ I ;$$

$${y}_{L} ( i ) = {y}_{H} ( i ) - {Δ}_{B} , , ∀ i ∈ I ;$$

This concludes the algorithm.

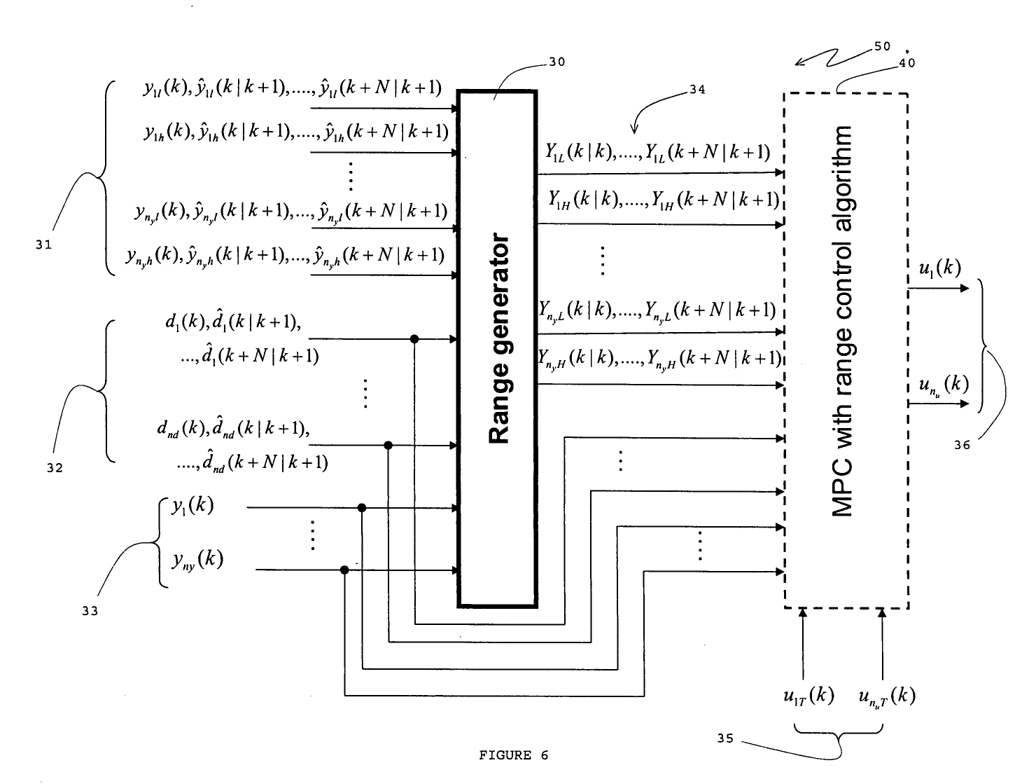

FIG. 6 is a basic block diagram of a system 50 having input-driven output ranges for model predictive control. The various inputs and outputs are discussed herein. A first set of inputs 31 to a range generator 30 may include set-range upper and lower bounds, current and future (anticipated). These inputs may be operator entered and/or computed by a super-ordinate optimizer. The inputs 31 may take the form of
y₁ₗ(k),ŷᵤ(k|k+1), . . . , ŷᵤ(k+N|k+1)
y₁ₕ(k),ŷ₁ₕ(k|k+1), . . . , ŷ₁ₕ(k+N|k+1)
yₙ_{_{y}}ₕ(k),ŷn_{_{y}}ₗ(k+1), . . . , ŷₙ_{_{y}}ₕ(k+N|k+1)
yₙ_{_{y}}ₕ(k), ŷₙ_{_{y}}ₕ(k|k+1), . . . , ŷₙ_{_{y}}ₕ(k+N|k+1)

Another set of inputs 32 may go to the range generator 30 and a MPC 40. The MPC 40 may contain a range control algorithm. The inputs 32 may include process disturbances, current and future (anticipated). These inputs may be measurements and predictions (by an external predictor). The inputs 32 may take the form of:
dₗ(k),\hat{d}ₗ(k|k+1), . . . , \hat{d}ₗ(k+N|k+1)
d_{nd}(k),\hat{d}_{nd}(k|k+1), . . . , \hat{d}ₗ(k+N|k+1)

A third set of inputs 33 may go to the range generator 30. Also, the inputs 33 may go to the MPC 40. The inputs 33 may include controlled variables which may be measurements of parameters of a plant or other physical installation, as an illustrative example, to be monitored and controlled by system 50. The inputs 33 may take the form of:
yₗ(k), . . . , y_{ny}(k)

Range generator 30 may provide a set of outputs 34 which may be to the MPC 40. Outputs 34 may include input-driven controlled variable ranges (which incorporate upper and lower range bounds). The outputs 34 may take the form of:
Y_{1L}(k|k), . . . , Y_{IL}(k+N|k+1)
Y_{1H}(k|k), . . . , Y_{lH}(k+N|k+1)
Yₙ_{_{y}}_{L}(k|k), . . . , Yₙ_{_{y}}_{L}(k+N|k+1)
Yₙ_{_{y}}_{H}(k|k), . . . , Yₙ_{_{y}}_{H}(k+N|k+1)

Another set of inputs 35 may include targets of manipulated variables from the super-ordinate optimizer. These inputs 35 may take the form of:
u_{1T}(k), . . . , uₙ_{ₛ}_{T}(k)

A set of outputs 36 of the system 50 from the MPC 40 may include manipulated variables for controlling a plant or other physical installation. The outputs 36 may take the form of:
u₁(k), . . . , uₙₛ(k)

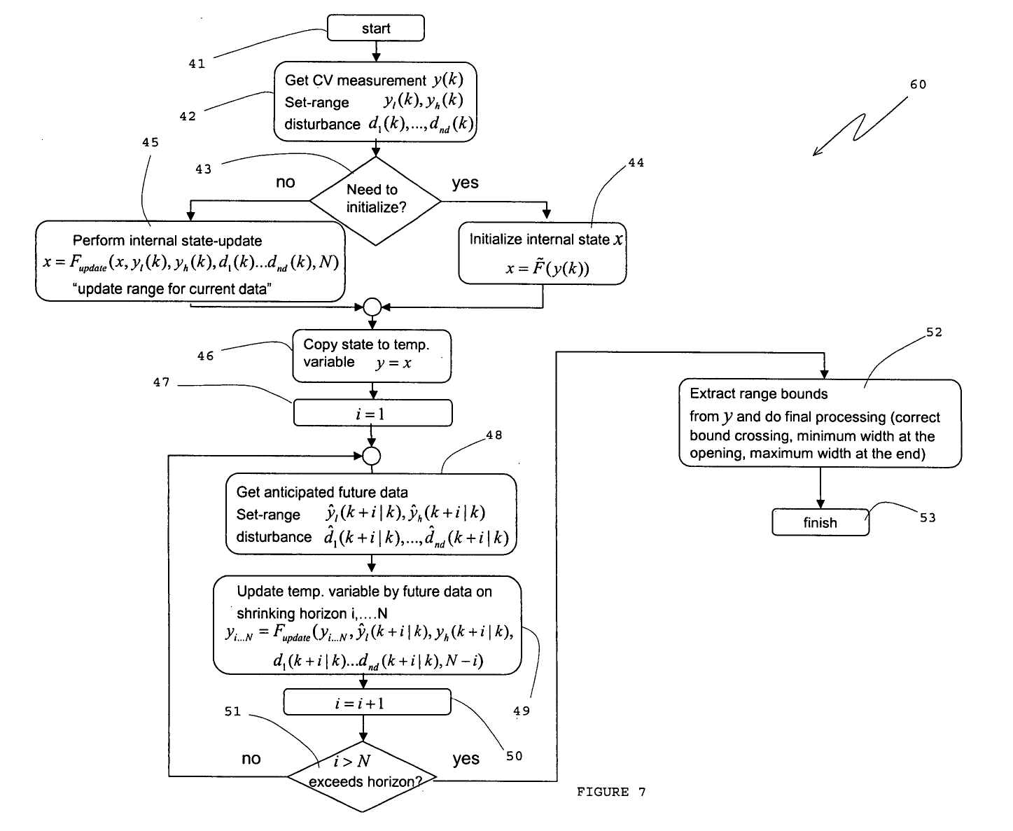

FIG. 7 is a basic flow diagram 60 for a one time step (in sync with the MPC 40 of FIG. 6). It is to be noted that it shows an algorithm already described above now emphasizing sequencing of command execution and data flow rather than the mathematical formulas. From a start 41, one may go to block 42 to get a CV measurement y(k), set-range
y₁(k), yₕ(k)
and disturbance
d₁(k), . . . , d_{nd}(k)
The next step is a decision at diamond symbol 43 to a question “Need to initialize?” If the answer is “Yes”, then the next step is “Initialize internal state x where
x=\tilde{F}(y(k))

In the above, a possible decision criterion for state initialization as well as initial values is noted.

If the answer is “No”, then the next step is block 45 where one may perform an internal update from current data
x=F_{update}(x, yₗ(k), yₕ(k) . . . d_{nd} (k) (k),N)

With an output from block 44 or 45, the next step is block 46 where one may copy a state to a temporary variable y=x. Then the next step is to set i=1 in block 47. Block 48 is the next step one may get anticipated future data such as set-range
ŷₗ(k+i|k), ŷₕ(k+i|k)
and disturbance
\hat{d}ₗ(k+i|k), . . . ,\hat{d}_{nd}(k+i|k)
Then one may go to block 49 and update the temporary variable by future data on a shrinking horizon i, . . . , N
Y_{i . . . N}=F_{update}(y_{i . . . N}, ŷₗ(k+i|k), yₙ(k+i|k),dₗ(k+i|k) . . . d_{nd}(k+i|k),N−i)

Then one may go to block 50 where i=i+1. The next step is a decision to a question at diamond 51 of whether i>N exceeds the horizon. If the answer is “No”, then one proceeds again through the steps of blocks 48, 49 and 50, and then again asks the question at diamond 51. The loop of blocks 48, 49 and 50 may be repeated as long as the answer is “No” and should stop when the answer is “Yes”. When the answer is “Yes”, then one may proceed to block 52 where the range bounds are extracted from y and do final processing (e.g., correct an accidental bound crossing, enforce minimum width at the opening and the maximum width at the end). The one may proceed to the finish block 53.

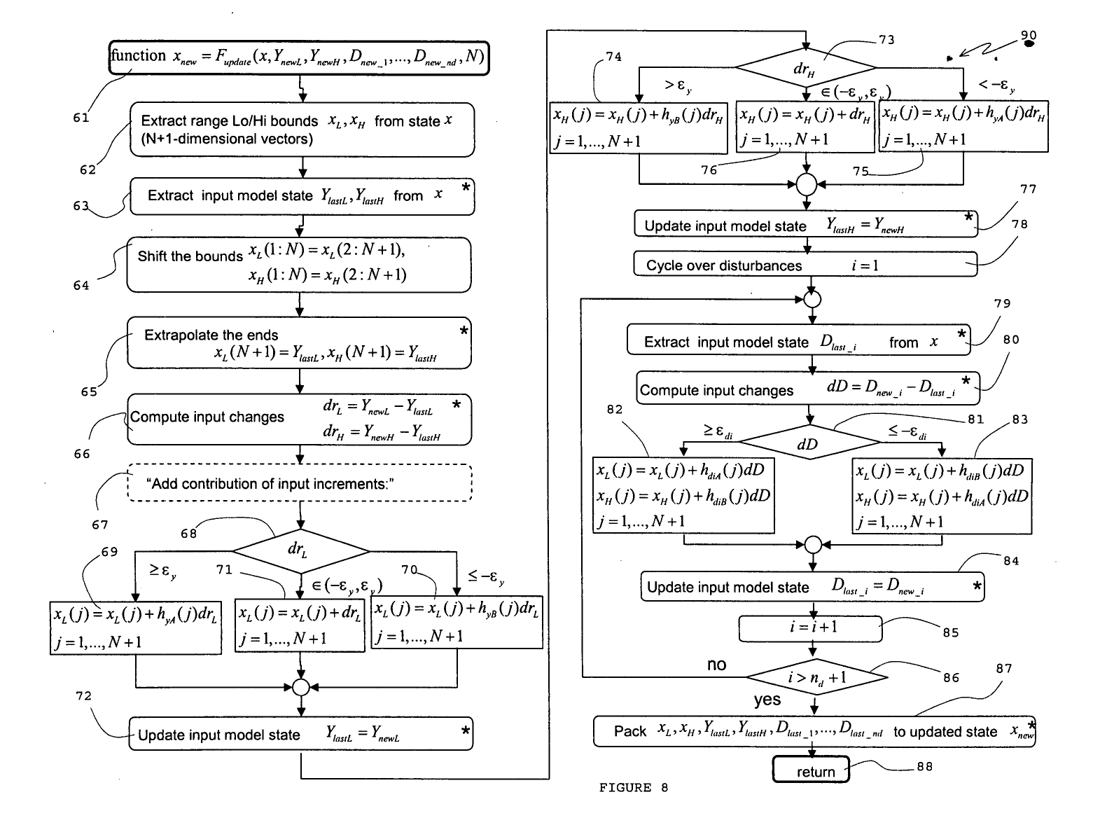

FIG. 8 is a flowchart 90 of a possible implementation of the state update function. The overall state contains states of the input models (see equation 4). The steps containing the manipulations with this state are marked by an asterisk. In the flowchart, a specific model for piecewise constant input, given by equation 5, is considered.

The flowchart 90 may start with a block 61 containing the function header with the list of input arguments (including the current state, set of current inputs and prediction horizon) and the output argument—the updated state. This function is called in blocks 45 and 49 of flowchart 60 (FIG. 7).
function x_{new}=F_{update}(x,Y_{newL},Y_{newH}, D_{new}_l, . . . , D_{new}_nd,N)
The next step is to extract data from the overall state x. The content of the state vector is described in Table 2. The last lower and upper range bounds generated by realized input increments (N+1-dimensional vectors), denoted as x_{L}, x_{H}, respectively, are extracted from state x in block 62. Then in block 63, input model states YI,L YIastH are extracted from x. The next step in block 64 is to shift the bounds:
x_{L}(1, . . . , N)=x_{L}(2, . . . , N+1),
x_{H}(1, . . . , N)=x_{H}(2, . . . , N+1)
Then the ends may be extrapolated in block 65 as follows:
x_{L}(N+1)=Y_{lastL},x_{H}(N+1)=Y_{lastH}
In the next step in block 66, the input changes may be completed:
dr_{L}=Y_{newL}−Y_{lastL}
dr_{H}=Y_{newH}−Y_{lastH}

A contribution of input increments may be added as follows:

A decision diamond 68 asks whether dr_{L} is ≧ε_{y} or ≦−ε_{y} or ε (−ε_{y}, ε_{y}). If the answer is dr_{L}≧ε_{y}, then in block 69 is the step
x_{L}(j)=x_{L}(j)+h_{yA}(j)dr_{L}, j=1, . . . , N+1
If the answer is dr_{L}≦−ε_{y}, then in block 70 is the step
x_{L}(j)=x_{L}(j)+h_{yB}(j)dr_{L}, j=1, . . . ,N+1
If the answer is dr_{L} ε (−ε_{y}, ε_{y}), then in block 71 is the step
x_{L}(j)=x_{L}(j)+dr_{L}, j=1, . . . , N+1
This corresponds to equation (12). After one of these steps in block 69, 70 or 71, then the input model state Y_{lastL} of block 63 may be updated in the step of block 72 as Y_{lastL}=Y_{newL.}
Next is a decision diamond 73 which asks whether dr_{H} is ≧ε_{y} or ≦−ε_{y} or ε (−ε_{y}, ε_{y}) (see equation (13). If the answer is dr_{H}≧ε_{y}, then in block 74 is the step
x_{H}(j)=x_{H}(j)+h_{yB}(j)dr_{H}, j=1, . . . , N+1
If the answer is dr_{H}≦−ε_{y}, then in block 75 is the step
x_{H}(j)=x_{H}(j)+h_{yA}(j)dr_{H}, j=1, . . . , N+1
If the answer is dr_{H} ε (−ε_{y}, ε_{y}), then in block 76 is the step
x_{H}(j)=x_{H}(j)+dr_{H}, j=1, . . . , N+1
After one of these steps in block 74, 75 or 76, then the input model state Y_{lastH}, of block 63 may be updated in the step of block 77 as Y_{lastH}=Y_{newH}.

The next step in block 78 is to cycle over the disturbances D_{new}_i, starting from i=1. Block 79 shows the step to extract the input model state Dₗₐₛₜ_i from x. Then there may be a computing of input changes dD=D_{new}_i−Dₗₐₛₜ_i in the step of block 80. Then a question of whether dD is ≧ε_{di} or ≦−ε_{di} may be asked as shown with a diamond symbol 81. If dD≧ε_{di}, then the next step is in block 82 as
x_{L}(j)=x_{L}(j)+h_{diA}(j)dD
x_{H}(i)=x_{H}(j)+h_{diB}(j)dD
j=1, . . . , N+1
If dD≦−ε_{di}, then the next step is in block 83 as
x_{L}(j)=x_{L}(j)+h_{diB}(j)dD
x_{H}(j)=x_{H}(j)+h_{diA}(j)dD
j=1, . . . , N+1
This corresponds to equations (14) and (15). After the step in block 82 or 83, then the input model state of block 79 may be updated as Dₗₐₛₜ_i=D_{new}_i in block 84. The next step in block 85 may be i=i+1. Then a question of whether i>n_{d}+1 in the diamond symbol 86 may be asked. If the answer is “no”, the one may return to step of block 79 and again proceed through the steps of symbols 79 to 86. One may continue to proceed repeatedly through that loop of symbols 79 to 86 until the answer to the question is “yes”. When the answer is “yes”, then the next step is of block 87 as “Pack x_{L},x_{H},Y_{lastL},Y_{lastH},Dₗₐₛₜ_1, . . . , Dₗₐₛₜ_nd to an updated state x_{new}.” Then one may go to a “return” block 88. This effectively means that the flowchart 90 has run its course for the moment and the execution of the algorithm returns back to flowchart 60.

The overall state of the flowchart 90 contains states of the input model (note equation 4). Steps containing manipulations with this state are marked with an asterisk “*” in the respectively marked blocks. In the flowchart 90, a specific model for piecewise constant input (given by equation 5) is considered. Furthermore, as was mentioned earlier, switched dynamical system can use a different representation; namely systems G_{yA}, G_{yB}, G_{d1A}, G_{d1B}, . . . may not be represented by functions h_{yA}, h_{yB}, h_{dlA}, h_{dlB}, respectively, but, e.g., by their state-space equations. In that case, the structure of the overall state may be different as well and so may be function F_{update}.

A comparison of simulated responses of a controller having ranges generated using this invention and a controller with classical funnels may be presented here. A traditional funnel algorithm may be reviewed.

Normally, the range may take shape of a funnel which is re-computed each step, regardless of past data, based on the current values ŷ(k|k), yₗ(k) and yₕ(k). Various shapes of the funnel and its representation may be used. One may consider the basic shape in FIG. 2.

Funnel opening may be computed from the current output estimate and two parameters K_{A} and K_{B}. Let

$${K}_{L} = \{ \begin{matrix}{K}_{A} & if & \hat{y} ( k \vert k ) \leq {y}_{l} ( k ) \\ {K}_{B} & if & \hat{y} ( k \vert k ) > {y}_{l} ( k ) ,\end{matrix} \\ {K}_{H} = \{ \begin{matrix}{K}_{B} & if & \hat{y} ( k \vert k ) \leq {y}_{h} ( k ) \\ {K}_{A} & if & \hat{y} ( k \vert k ) > {y}_{h} ( k ) .\end{matrix} \qquad ( 18 )$$

The funnel opening may then be computed as
Y_{L}(k|k)=ŷ(k|k)−max{|K_{L}(ŷ(k|k)−yₗ(k))|, yₕ(k)−yₗ(k)} (19)
Y_{H}(k|k)=ŷ(k|k)+max{|K_{H}(ŷ(k|k)−yₕ(k))|, yₕ(k)−yₗ(k)}
The funnel width may be, at the beginning for k=0, at least twice of the width of the operator set range (defined somewhat arbitrarily which may be changed if appropriate). The funnel shape may be further determined by parameter N_{c} that controls the response speed. The range formulas are

$${Y}_{L} ( k + j \vert k ) = \{ \begin{matrix}{Y}_{L} ( k \vert k ) + \frac{{y}_{l} ( k ) - {Y}_{L} ( k \vert k )}{{N}_{c}} j & if 0 \leq j < {N}_{c} \\ {y}_{l} ( k ) & if {N}_{c} < j \leq {N}_{e}\end{matrix} \\ {Y}_{H} ( k + j \vert k ) = \{ \begin{matrix}{Y}_{H} ( k \vert k ) + \frac{{y}_{h} ( k ) - {Y}_{H} ( k \vert k )}{{N}_{c}} j , & if 0 \leq j < {N}_{c} \\ {y}_{h} ( k ) & if {N}_{c} < j \leq {N}_{e}\end{matrix} \qquad ( 20 )$$

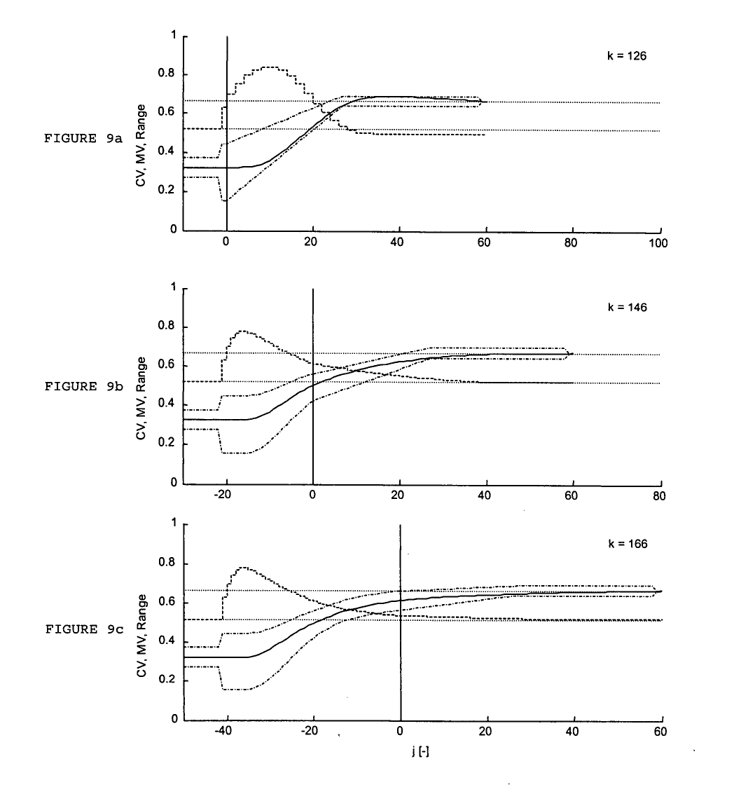

Now one may present an illustrative simulational example of master pressure control in a combined heat and power plant. (Other kinds of simulational examples besides the plant may be applicable here.) However, as to the plant example, the controlled variable may be steam pressure in a steam header which is supplied by several units (boilers). A manipulated variable may be the total fuel flow to all boilers. The disturbance may be the steam mass-flow off the header to turbines, reducing stations, and so forth. As this simulation is presented to compare two strategies of generating CV ranges, one may omit details about the particular plant model and controller setting, which may be the same in both cases. An important fact may be a significant time-delay and slow dynamics in the MV-to-CV channel. Furthermore, there may be an integrator at the output of the plant model. Sampling period may be assumed to be 6 seconds. First, one may show responses to a set-range step for a funnel given by equation (19) and equation (20), where K_{A}=0.6, K_{B}=0.3 and N_{c}=28. The time horizon may be N=60. The plots show a time window [k−50, k+60 ] for three time instants k. The values plotted may be indicated in the following. The lower range bound may be plotted, for fixed k, as Y_{L}(k−50|k−50), . . . , Y_{L}(k|k), Y_{L}(k+1|k), . . . , Y_{L}(k+N|k). Similarly, the upper range bound may be plotted as the sequence Y_{H}(k−50|k−50), . . . , Y_{H}(k|k), Y_{H}(k+1|k), . . . , Y_{H}(k+N|k). Both bounds may be plotted by dash-dotted lines. Further, solid lines may be for CV: ŷ(k+j|k+j) for j=−50, . . . , 0 and ŷ(k+j|k) for j=1, . . . , N. Finally, dashed stair-wise line shows recorded/predicted MV (u(k+j) and u(k+j|k), respectively). All variables may be dimensionless, normalized to the range [0,1]. The plot is in FIGS. 9a, 9b and 9c and which show the closed-loop responses to set-range step, the classical funnel. It may be observed that the funnel changes its shape during the entire transition. The speed of approaching the set range may fall significantly as the CV trajectory approaches this set-range.

For comparison, one may do the same simulations for input-driven ranges. The range shape may be determined by two functions, h_{yA} and h_{yB} defined in equation (9). In the present case, they may be step-responses of dynamical systems with transfer functions G_{yA}(s) and G_{yB}(s), respectively, which are given by

$${G}_{yA} ( s ) = \frac{1.3}{{( 6.62 s + 1 )}^{2}} exp ( - 5.13 s ) - 0.3 , \\ {G}_{yB} ( s ) = \frac{0.9}{{( s / 0.126 )}^{2} + 2 \cdot 0.75 ( s / 0.126 ) + 1} exp ( - 4.44 s ) + 0.1 . \qquad ( 21 )$$

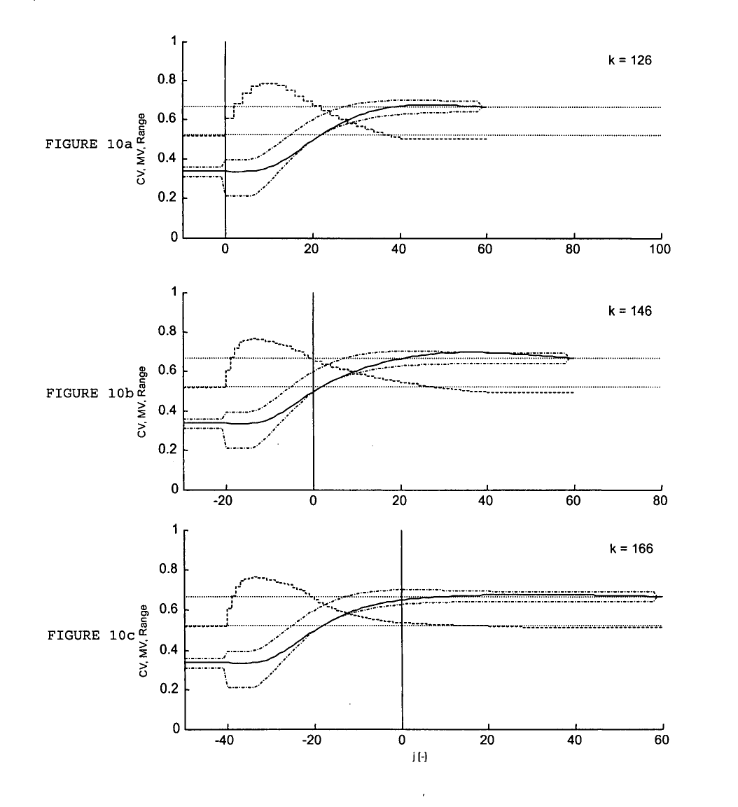

These transfer functions may be chosen so that the closed-loop response to the set-range step is similar as in the case of the classical funnel (see FIGS. 10a, 10b and 10c). FIGS. 10a, 10b and 10c show the closed-loop responses to set-range step, the input-driven range. The CV range response may follow that computed in the past. As a result, the CV and MV response trajectories may be similar to their past predictions.

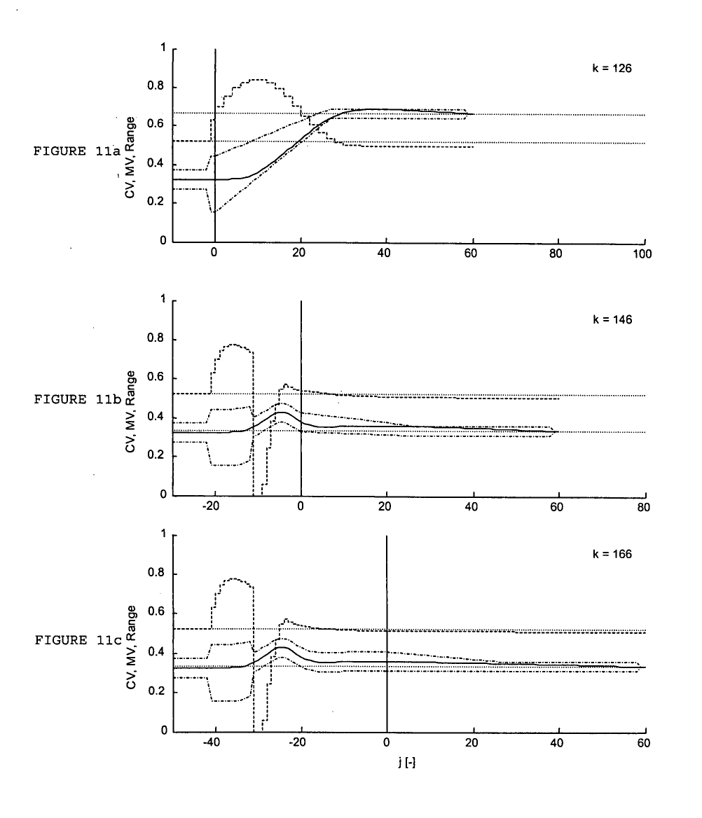

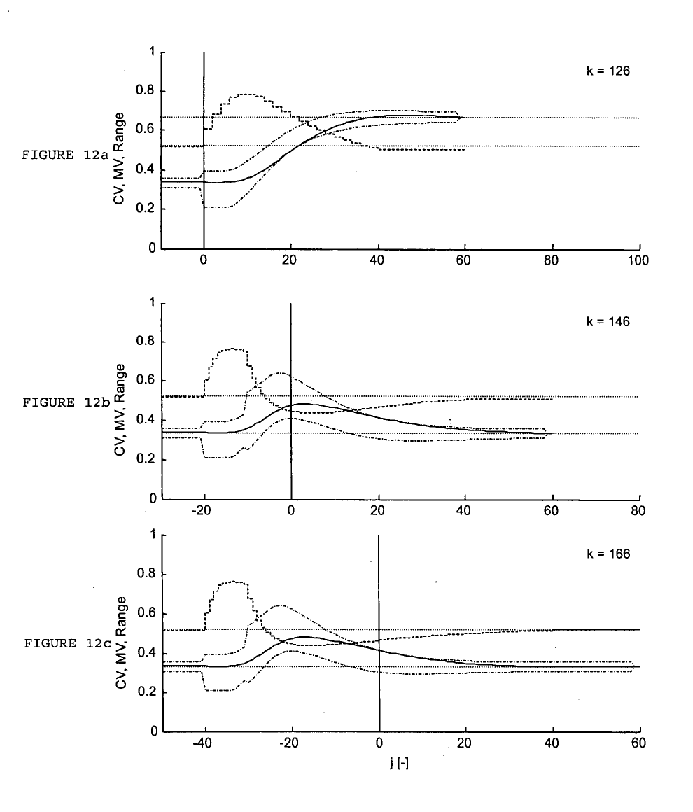

Simulations in FIGS. 9a, 9b and 9c and FIGS. 10a, 10b and 10c suggest that both range algorithms produce similar results. However, the responses may be very different if an input abruptly changes during the transition. As an example, one simulate the situation of a set-range step, which is followed, after ten sampling intervals, by another step of equal size and opposite direction, thus making a short rectangular pulse. Classical funnels do not necessarily take into account the inertias in the controlled plant, resulting in overly aggressive MV response, as seen in FIGS. 11a, 11b and 11c. FIGS. 11a, 11b and 11c show a closed-loop response to set-range pulse—the classical funnel. In practice, this effect may be relieved by set-range filtering (as described in U.S. Pat. No. 5,561,599) as well as setting wider funnel openings; however, that may cause slowing the responses to stand-alone set-range steps. On the other hand, the internal dynamics of the input-driven range does not necessarily allow reversing the range abruptly and therefore, may result in more sensible MV trajectories (see FIGS. 12a, 12b and 12c). FIGS. 12a, 12b and 12c show closed-loop responses to set-range pulse: input-driven range.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A system for providing ranges for model predictive control comprising:
a range generator;
a model predictive controller connected to the range generator; and
range bound outputs of the range generator to the model predictive controller.

2. The system of claim 1, further comprising:
upper set-range bound and lower set-range bound inputs to the range generator;
disturbance inputs to the range generator; and
controlled variable inputs to the range generator and the model predictive controller.

3. The system of claim 2, wherein the disturbance inputs are process disturbance inputs.

4. The system of claim 3, wherein the range bound outputs are input-driven ranges for controlled variables.

5. The system of claim 4, wherein:
the set-range upper bound and lower bound inputs have current and anticipated information; and
the process disturbance inputs have current and anticipated information.

6. A system for range generation comprising:
obtaining current input data comprising controlled variable measurement information, set-range information and disturbance information;
initializing as needed or doing an update of an internal state of switched dynamics for current data; and
predicting future output trajectories of a switched dynamical system for a given N time-steps horizon, from an updated state.

7. The system of claim 6, further comprising:
copying the internal state to a temporary state variable;
obtaining anticipated future data comprising a set range and disturbance for each future time instant i, i=1, 2, . . . , N;
updating the temporary state variable with future data as well as future output predictions of the switched dynamical system up to N time-steps ahead from current time; and
getting upper range and lower range bounds as predicted output trajectories of the switched dynamical system from the temporary state variable.

8. The system of claim 7, further comprising:
keeping the updated state for the next step; and
discarding the temporary state; and
wherein the system is based on a switched dynamical system trajectory prediction.

9. The system of claim 8, further comprising:
updating the internal state or the temporary state of switched dynamics of the system;
deciding, for each input, a size and direction of a current input change based on an appropriate input model and represented by an input error variable;
setting internal switches based on sizes and signs of input error variables; and
computing new values of states for internal subsystems for a given setting of switches.

10. The system of claim 9, further comprising computing the upper range and lower range bounds using internal state and temporary state variables.

11. The system of claim 10, wherein the switched dynamical system per each controlled variable comprises:
two outputs comprising the range upper and range lower bounds;
an input set comprising set-range upper and lower bounds; and
an input set comprising disturbances.

12. The system of claim 11 wherein:
the range upper bound is a sum of contributions from the set-range upper bound and from a set of disturbances;
the range lower bound is a sum of contributions from the set-range lower bound and from the set of disturbances; and
a particular input contributes to a range bound through a response of a switched dynamical sub-system.

13. The system of claim 12, wherein the switched dynamical subsystem comprises:
an input model for determining the input error variable; and
a controlled switch which connects the input error variable to one or none out of at least two dynamical sub-subsystems; and
wherein:
the controlled switch is controlled by a size and direction of the input error variable; and
outputs of the dynamical sub-subsystems, whether having their inputs connected to the input error variable or not, jointly contribute to the range bound.

14. The system of claim 13, wherein switched dynamical subsystems are driven by a same disturbance and contribute to upper range bound and lower range bound, respectively, and are a symmetric pair of switched dynamical subsystems comprising:
a same input model;
a same input error;
a same set of dynamical sub-subsystems; and
an opposite switch setting with respect to a sign of input error in that a subsystem contributing to the upper range bound has an input error connected to the same sub-subsystem as would a subsystem contributing to the lower range bound have if the input error were of opposite sign.

15. The system of claim 13, wherein:
a first switched dynamical subsystem is driven by the set-range upper bound and contributes to the range upper bound;
a second switched dynamical subsystem is driven by the set-range lower bound and contributes to the range lower bound; and
the first and second first switched dynamical subsystems are a symmetric pair of subsystems comprising:
a same input model but with dissimilar input errors as driving inputs may be different;
a same set of dynamical sub-subsystems; and
opposite switch settings with respect to the sign of input error.

16. A method for providing ranges for a model predictive control, comprising:
providing input-driven range bounds for model predictive control; and
wherein the input-driven range bounds are input- driven controlled variable ranges.

17. The method of claim 16, wherein the input-driven range bounds are from a range generator.

18. The method of claim 17, further comprising providing set-range upper and lower bounds to the range generator.

19. The method of claim 18, further comprising designing a switched dynamical system and its internal dynamics conditions for sub-subsystems such that resulting range bounds do not cross under normal operating conditions.

20. The method of claim 18, further comprising:
providing controlled variable values to the range generator; and
providing process disturbance values to the range generator.

21. The method of claim 20, wherein:
the set-range upper and lower bounds contain present and future information; and
the process disturbance values contain present and future information.
